(19) United States
(12) Patent Application Publication
(10) Pub. No.: US 2026/0356493 A1
(43) Pub. Date: Nov. 12, 2026

(54) MANDREL-SUPPORTED UMBILICAL RELEASE MECHANISM

(71) Applicant: BLUE ORIGIN MANUFACTURING, LLC, Huntsville, AL (US)

(72) Inventor: Alvaro Aguilar, Titusville, FL (US)

(21) Appl. No.: 19/202,908

(22) Filed: May 8, 2025

(51) Int. Cl. B64F 1/04

(52) U.S. Cl. CPC B64F 1/04

(57) ABSTRACT

Systems and methods disclosed herein are for a mandrel-based section of an umbilical release mechanism (URM) to be in a locked position with a receiver-based section. The mandrel-based section may be configured to support or allow a mechanical or pneumatic-pressure primary engagement and a pneumatic-pressure primary disengagement between a receiver-based section and the mandrel-based section and through a receiver of the receiver-based section. The mandrel-based section may be also configured to support or allow a mechanical-pressure secondary engagement and disengagement between the receiver-based section and the mandrel-based section and through the receiver.

### TECHNICAL FIELD

The present disclosure is generally related to release mechanisms, such as umbilical release mechanisms (URMs), and methods associated therewith and, in at least one aspect, is specifically related to a mandrel-supported or based URM.

### BACKGROUND

Launch vehicles include various components, including umbilical release mechanisms (URMs) which may be used to allow a locked position between at least two umbilical panels. The locked position may be a latching together of the two umbilical panels. In the locked position, various media may be transferred through other connections between the two the two umbilical panels and between launch vehicle and ground features hosting the two umbilical panels. The URMs may be heavily used and may need extensive refurbishing after each use. The URMs may offer redundant triggers which may not be fault-tolerant for human-rated flights.

### SUMMARY

In one non-limiting example, a system for release mechanism may include a first section and a second section to be used with a launch vehicle and a ground feature. The release mechanism may be a mandrel-supported or based umbilical release mechanism (URM) or may be associated with a mandrel-supported or based URM. In some examples, the mandrel-supported or based URM may include a pneumatic-pressure primary engagement and disengagement release mechanism and a fault-tolerant mechanical-pressure secondary engagement and disengagement release mechanism. In some examples, the mandrel-supported or based URM may include a mechanical or pneumatic-pressure primary engagement and a pneumatic-pressure primary disengagement release mechanism. The mandrel-supported or based URM may be fault-tolerant for human-rated flights, may be heavily used, and may not need extensive refurbishing after each use as there may be reduced components or moving parts.

The first section and the second section may be located on different umbilical panels for the launch vehicle and the ground feature. The mandrel-supported or based URM may support or allow coupling of the umbilical panels into a locked position by a union of the first section and the second section of the mandrel-supported or based URM. The locked position of the umbilical panels may allow transfer of media to be performed between the launch vehicle and the ground feature. The union of the umbilical panels, by virtue of the mandrel-supported or based URM, may be able to withstand high loads. A footprint of the system may support retrofitting of the mandrel-supported or based URM into a URM provision of the umbilical panels, in one example. The system may be re-usable and may not need refurbishment of parts. At least the mechanical or pneumatic-pressure primary engagement and a pneumatic-pressure primary disengagement and the fault-tolerant mechanical-pressure secondary engagement release mechanism may be used for a routine transfer of the media, while the mechanical-pressure secondary disengagement release mechanism may be used for an emergency or back-up disengagement of the umbilical panels.

The system may include a receiver in the first section, with the receiver configured to bias a release feature, which may be within the receiver. The bias may be so that the release feature may be in a locked position along with the first section and the second section. The system may include a mandrel which may be within the second section and which may be configured to support or allow the mechanical or pneumatic-pressure primary engagement and a pneumatic-pressure primary disengagement between the first section and the second section and through the receiver. In addition, the mandrel may be configured to support or allow the mechanical-pressure secondary engagement and disengagement between the first section and the second section and through the receiver.

In one non-limiting aspect, the disclosure herein may be for a mandrel-based section of the URM. The mandrel-based section of the URM may include configuration to support or allow a mechanical or pneumatic-pressure primary engagement and a pneumatic-pressure primary disengagement between a receiver-based section and the mandrel-based section. The pneumatic-pressure primary engagement and disengagement may be through a receiver of the receiver-based section. The mandrel-based section of the URM may also include configuration to support or allow a mechanical-pressure secondary engagement and disengagement between the receiver-based section and the mandrel-based section. The mechanical-pressure secondary engagement and disengagement between the receiver-based section and the mandrel-based section may be also through the receiver of the receiver-based section.

In another non-limiting aspect, the disclosure herein may be for a method for a release mechanism. The method may include determining to associate together a first section and a second section of the release mechanism. The method may include biasing, using a receiver in the first section, a release feature which may be also within the receiver. The biasing may provide a locked position for the release feature, along with the first section and the second section. The method may include supporting or allowing a mechanical or pneumatic-pressure primary engagement and a pneumatic-pressure primary disengagement between the first section and the second section. This step may include using a mandrel within the second section and using the receiver. The method may include supporting or allowing a mechanical-pressure secondary engagement and disengagement between the first section and the second section. This step may also include using the mandrel and the receiver.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a system for a mandrel-supported or based release mechanism, in accordance with at least one non-limiting aspect of the present disclosure;

FIG. 2A illustrates perspective aspects of a mandrel-supported or based release mechanism, in accordance with a further non-limiting aspect of the present disclosure;

FIG. 2B illustrates further aspects of a mandrel-supported or based release mechanism, in accordance with a further non-limiting aspect of the present disclosure;

FIG. 2C illustrates cross-section aspects of a receiver-based section, in accordance with a further non-limiting aspect of the present disclosure;

FIG. 2D illustrates cross-section aspects of a mandrel-based section, in accordance with a further non-limiting aspect of the present disclosure;

FIG. 3A illustrates aspects of a mandrel in a mandrel-supported or based release mechanism, in accordance with a further non-limiting aspect of the present disclosure;

FIG. 3B illustrates aspects of a biasing feature used to allow or support a bias in the release rod to be in a locked position with a release feature in the mandrel-supported or based release mechanism, in accordance with a further non-limiting aspect of the present disclosure;

FIG. 3C illustrates aspects of a release rod in a mandrel-supported or based release mechanism, in accordance with a further non-limiting aspect of the present disclosure;

FIG. 3D illustrates aspects of a release feature in a mandrel-supported or based release mechanism, in accordance with a further non-limiting aspect of the present disclosure;

FIG. 3E illustrates aspects of a pneumatic-pressure primary engagement and of a mechanical-pressure secondary engagement in a mandrel-supported or based release mechanism, in accordance with a further non-limiting aspect of the present disclosure;

FIG. 3F illustrates aspects of a pneumatic-pressure primary disengagement in a mandrel-supported or based release mechanism, in accordance with a further non-limiting aspect of the present disclosure;

FIG. 3G illustrates aspects of purging performed in a mandrel-supported or based release mechanism, in accordance with a further non-limiting aspect of the present disclosure;

FIG. 3H illustrates aspects of mechanical-pressure secondary disengagement in a mandrel-supported or based release mechanism, in accordance with a further non-limiting aspect of the present disclosure;

FIG. 3I illustrates aspects of mechanical-pressure primary engagement in a mandrel-supported or based release mechanism, in accordance with a further non-limiting aspect of the present disclosure;

FIG. 3J illustrates aspects of threaded retainer in a mandrel-supported or based release mechanism, in accordance with a further non-limiting aspect of the present disclosure;

FIG. 4 illustrates an example space mission having components benefiting from the mandrel-supported or based release mechanism, in accordance with a further non-limiting aspect of the present disclosure;

FIG. 5 illustrates a method associated with a system used for mandrel-supported or based release mechanism, in accordance with a further non-limiting aspect of the present disclosure; and

FIG. 6 illustrates a further method associated with a system used for mandrel-supported or based release mechanism, in accordance with a further non-limiting aspect of the present disclosure.

### DETAILED DESCRIPTION

As human-launches may need redundancies for safety reasons, a system for a mandrel-supported or based release mechanism herein may be an umbilical release mechanism (URM). The mandrel-supported or based URM may include a combination of a mechanical or pneumatic-pressure primary engagement and a pneumatic-pressure primary disengagement release mechanism and a fault-tolerant mechanical-pressure secondary engagement and disengagement release mechanism. The mandrel-supported or based URM may be able to support higher than tens of thousands of pounds in a few dozen square inches of a footprint, for instance, with respect to tensile capacity to withstand without a premature separation. In addition, the mandrel-supported or based URM may be able to support a varying amount of tensile capacity which may be provided within a limited space of at least a pair of umbilical panels between a ground feature (such as of a launchpad) and a launch vehicle.

In one example, the engagement may be in reference to a first feature (such as a ground feature) having a first section of a mandrel-supported or based URM being engaged with a second feature (such as a launch vehicle feature) having a second section of the mandrel-supported or based URM. The engagement may be so that transfer or media may be performed between the first feature and the second feature. The media may include tangible media (such as liquid and gases), as well as non-tangible media (such as communication and power). The media itself may be transferred by respective connectors suitable to the media at issue.

The disengagement may be in reference to the first feature being disengaged from the second feature by the mandrel-supported or based URM being separated after the media transfer is completed, as part of a routine transfer, or after or before the media transfer is completed in the case of emergency. In one example, the primary engagement, primary disengagement, and secondary engagement may be part of the routine transfer of media. In one example, the secondary disengagement may be part of the case of emergency. At least the primary engagement and the primary disengagement are pneumatic. At least the secondary engagement and the secondary disengagement are mechanical. In some examples, the primary engagement may be mechanical. For instance, there may a bias towards engagement for the mandrel-based section and the receiver-based section. A coil spring may be used such that pneumatic use may be only applied for the primary disengagement. For instance, when pressure is released as part of a primary disengagement, the mandrel-based section may disengage from the receiver-based section. The pneumatic-pressure primary engagement may need ports for the pneumatic pressure and the mechanical-pressure primary engagement may not need ports.

While ball-bearings may be used in a URM, they may offer limited surface area the tensile capacity capable within a mandrel-supported or based URM. In addition, a URM having solid segments may not be flexible, but spherical surfaces and conical structures may support an element of flexibility in a URM. In at least one example, the mandrel-supported or based URM herein may include a receiver in the receiver-based section. The receiver may be to bias a release feature, which may be within the receiver. The basis may be for the release feature to be in a locked position along with the receiver-based section and a mandrel-based section. There may be dogs between the receiver and an inner housing, and which may be through the mandrel. The dogs are also to be in the locked position with the release feature. The dogs may interface with the inner housing, which may also be a piston and which may be subject to the pneumatic-pressure primary engagement and disengagement. In the mechanical or pneumatic-pressure primary engagement, the inner housing may be moved so that it pushes the dogs against the receiver and so that it is parallel and over the dogs. The inner housing being parallel and over the dogs may apply circumferential pressure to the dogs and may be so that the dogs are not allowed to fall back into dog catches of the inner housing.

The mandrel-supported or based URM herein may include lock ports to receive media at a pressure associated with the pneumatic-pressure primary engagement. The mandrel-supported or based URM herein may include unlock ports to receive a media at a pressure for the pneumatic-pressure primary disengagement. In some examples, the pneumatic-pressure primary disengagement allows the mandrel-supported or based URM to be used in cryogenic applications where hydraulic fluid, if used, would freeze, relative to pneumatic use. The media may be a same media and the pressure may be predetermined for the pneumatic-pressure primary engagement and disengagement. In addition, mandrel-supported or based URM herein may include a release rod through the mandrel and which may be biased to also be in the locked position with the release feature. The release rod may be configured for the mechanical-pressure secondary engagement and disengagement between the receiver-based section and the mandrel-based section, through the receiver. The release rod, and therefore, the mechanical-pressure secondary disengagement, may be associated with a pressure which may be higher than a pressure used for one or more of the pneumatic-pressure primary engagement or the mechanical-pressure secondary engagement.

The unlock ports for the pneumatic-pressure primary disengagement may be able to receive media with enough pressure to overcome friction of the inner housing or piston and of the dogs. In one example, a threaded retainer may be used to remove loading on the mandrel-supported or based URM. The threaded retainer may be able to remove any loading on the mandrel-supported or based URM when the receiver-based section and the mandrel-based section are together in the locked position. The threaded retainer may also remove load on any bellows associated with the mandrel-supported or based URM. In one example, the preload may be represented by a thousandth of an inch of movement so that the piston or inner housing and the threaded retainer may be moved together as part of the preloading from the threaded retainer. In addition, in areas near cryogenic activities, all areas (such as internals) of the mandrel-supported or based URM may need venting. For example, liquid hydrogen (H₂) may be flowing in the areas and there may be a possibility for condensation and icing within the areas. The mandrel-supported or based URM may include purge capability and may use gaseous helium (He) or nitrogen for purging the areas. Helium may be preferred for applications where a temperature around the mandrel-supported or based URM is expected to be near-cryogenic state, while nitrogen gas may be sufficient for a mandrel-supported or based URM in non-near-cryogenic environments. One or more of the materials in the mandrel-supported or based URM may include a nickel alloy, a composite of nickel alloy, copper-beryllium, a composite of copper-beryllium, or stainless steel. The one or more materials may include materials having a high yield strength, in one example. One or more of the materials in the mandrel-supported or based URM may include high strength corrosion resistant materials such as a high-strength, high-temperature, and precipitation-hardening iron-nickel-chromium alloy (such as A-286), or may include stainless steel or aluminum-bronze. At least aluminum-bronze may be used due to its anti-galling properties.

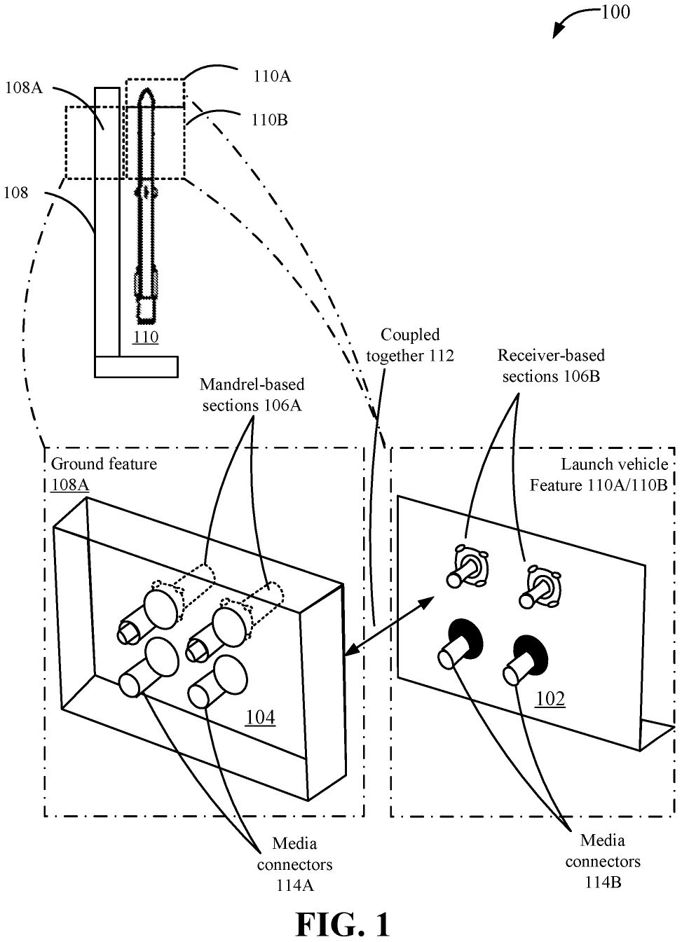

FIG. 1 illustrates a system 100 for a mandrel-supported or based release mechanism, in accordance with at least one non-limiting aspect of the present disclosure. The system 100 may include umbilical panels 102, 104 on opposing features, such as a ground feature 108A of a launchpad 108 and a launch vehicle feature 110A, 110B of a launch vehicle 110. The launch vehicle feature 110A, 110B may include a stage of a launch vehicle. The stage may include one or more modules for communications, humans, or cargo (generally referred to as payload), and may include a propellant or fuel tank. The umbilical panels 102, 104 may include respective sections of a mandrel-supported or based release mechanism. The respective sections may include one or more mandrel-based sections 106A which may be coupled together 112 with respective ones of receiver-based sections 106B. The mandrel-based sections 106A may be on an umbilical panel 104 of a ground feature 108A. The receiver-based sections 106B may be on an umbilical panel 102 of a launch vehicle feature 110A, 110B (excerpts of which are illustrated in the callout sections).

The mandrel-supported or based release mechanism may be used to hold together essential connections between the launchpad 108 and a launch vehicle 110 prior to a launch. In one example, the ground feature 108A and the launch vehicle feature 110A, 110B may be associated with fuel umbilical panels (for example, liquid hydrogen and liquid oxygen), electrical power connection umbilical panels, communications and data transfer umbilical panels, coolant umbilical panels, purge gases (for example, nitrogen and helium) umbilical panels, and others. The fuel, electrical power connection, communications and data transfer, coolant, purge gases, and the like may be provided by respective media connectors 114A, 114B, once the umbilical panels 102, 104 are coupled together 112 in a locked position using one or more mandrel-based sections 106A and receiver-based sections 106B of a mandrel-supported or based release mechanism.

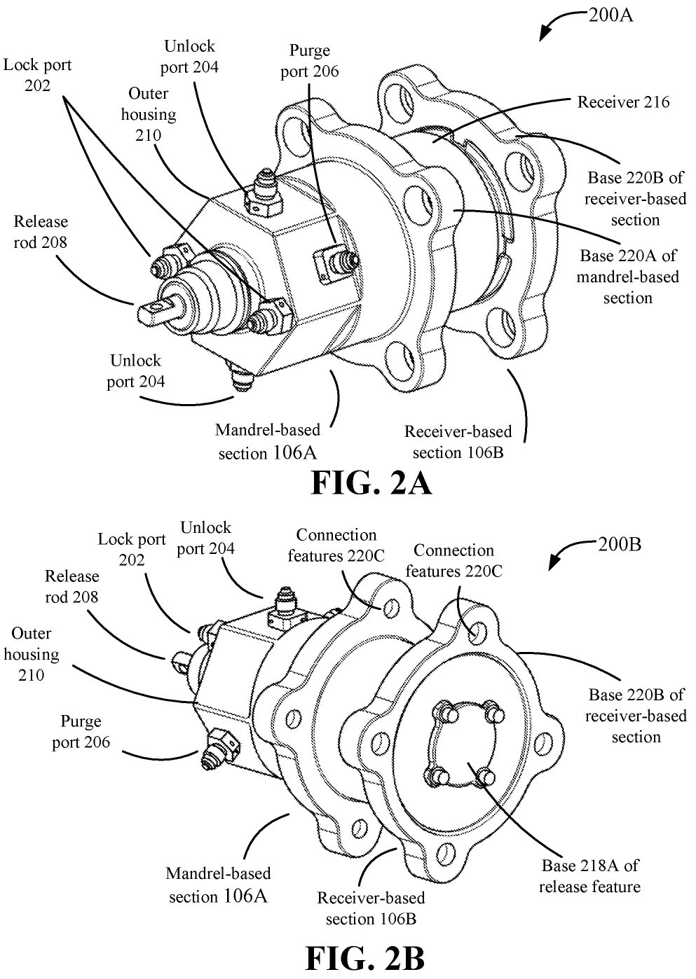

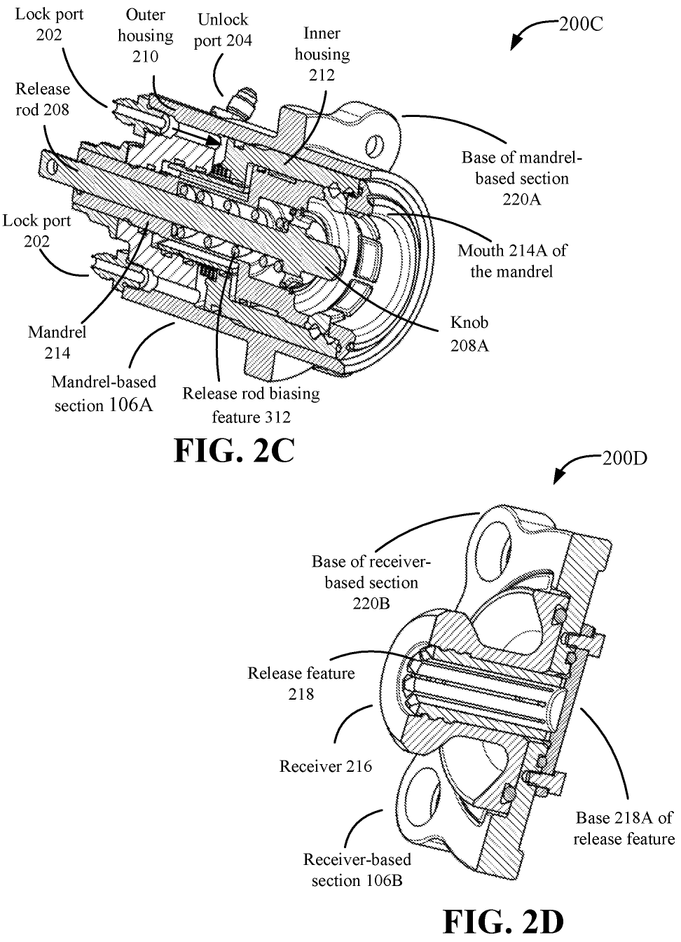

FIG. 2A illustrates perspective aspects 200A of a mandrel-supported or based release mechanism, in accordance with a further non-limiting aspect of the present disclosure. The perspective aspects 200A illustrated may be in the system 100 for a mandrel-supported or based URM. The mandrel-supported or based URM may include a first section which may be a receiver-based section 106B located on a launch vehicle 110, as part of a launch vehicle feature 110A, 110B. The mandrel-supported or based URM may include a second section which may be a mandrel-based section 106A located on a launchpad 108 or associated with the launchpad 108, as part of a ground feature 108A.

In one example, the launch vehicle feature 110A, 110B may include the receiver-based section 106B by a coupling between a base 220B of receiver-based section 106B with the launch vehicle feature 110A, 110B. In another example, the ground feature 108A, associated with the launchpad 108, may include mandrel-based section 106A by a coupling between a base 220A of the mandrel-based section 106A with the ground feature 108A. Each of the ground feature 108A and the launch vehicle feature 110A, 110B may include an appropriate umbilical panel 102, 104 to support the mandrel-supported or based URM and to support any connectors suitable to media to be transferred between the ground feature 108A and the launch vehicle feature 110A, 110B.

The receiver-based section 106B may include a receiver 216. The mandrel-based section 106A may include at least one lock port 202 but there may be two lock ports on opposite sides of a top of the mandrel-based section 106A. A lock port 202 may be configured to receive a media for the pneumatic-pressure primary engagement. The mandrel-based section 106A may include at least one unlock port 204 but there may be two unlock ports on opposite sides of a top of the mandrel-based section 106A. An unlock port 204 may be configured to receive a media for the pneumatic-pressure primary disengagement. The media for engagement and disengagement may be the same or may be different media.

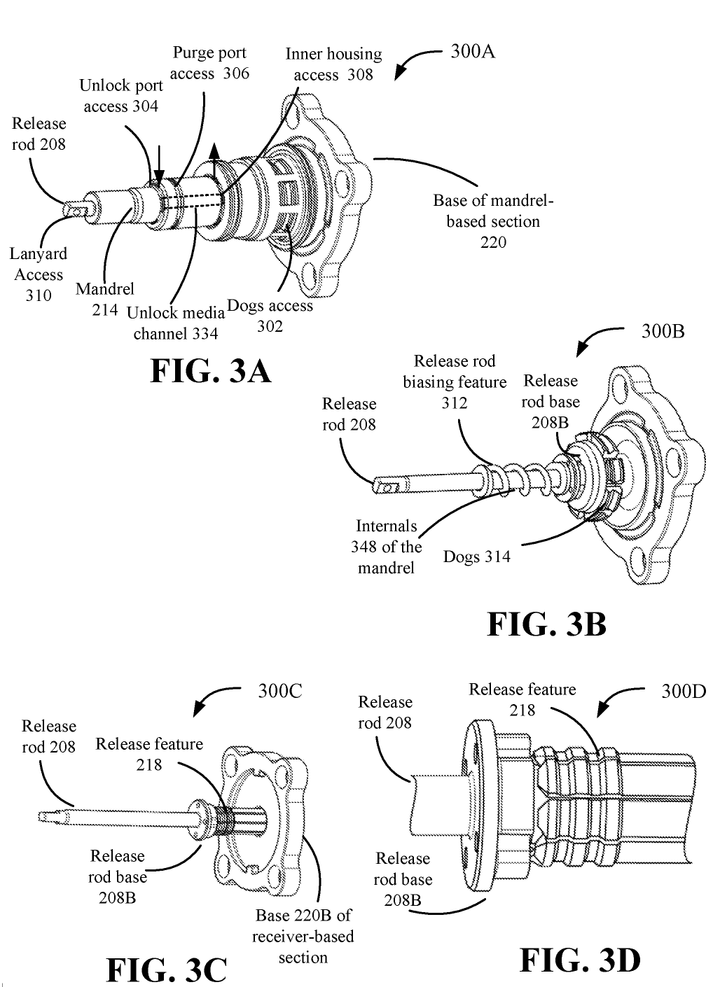

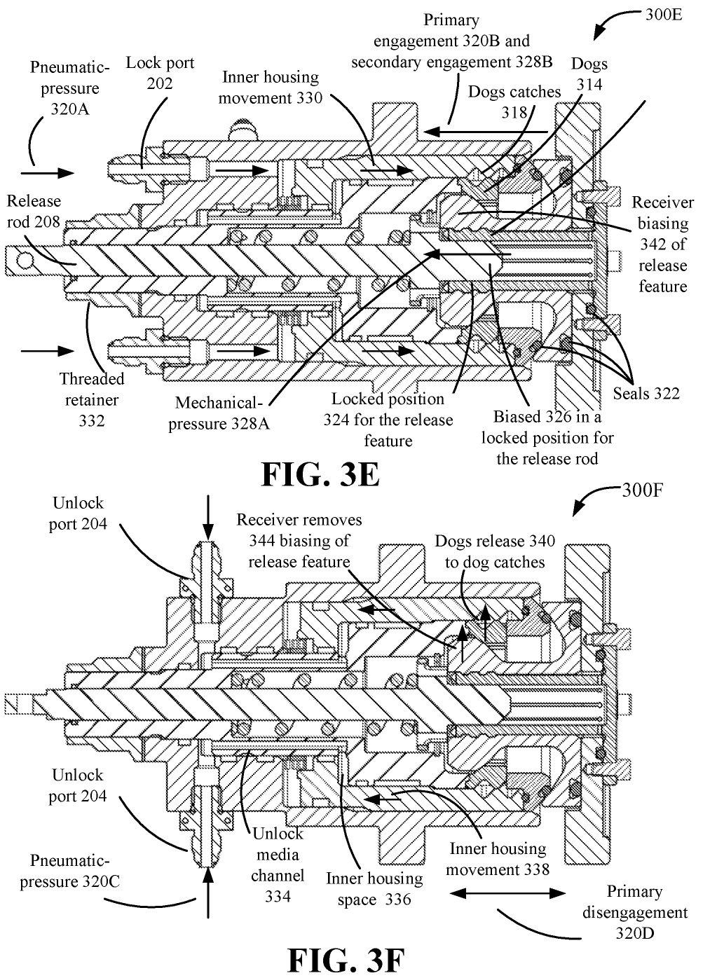

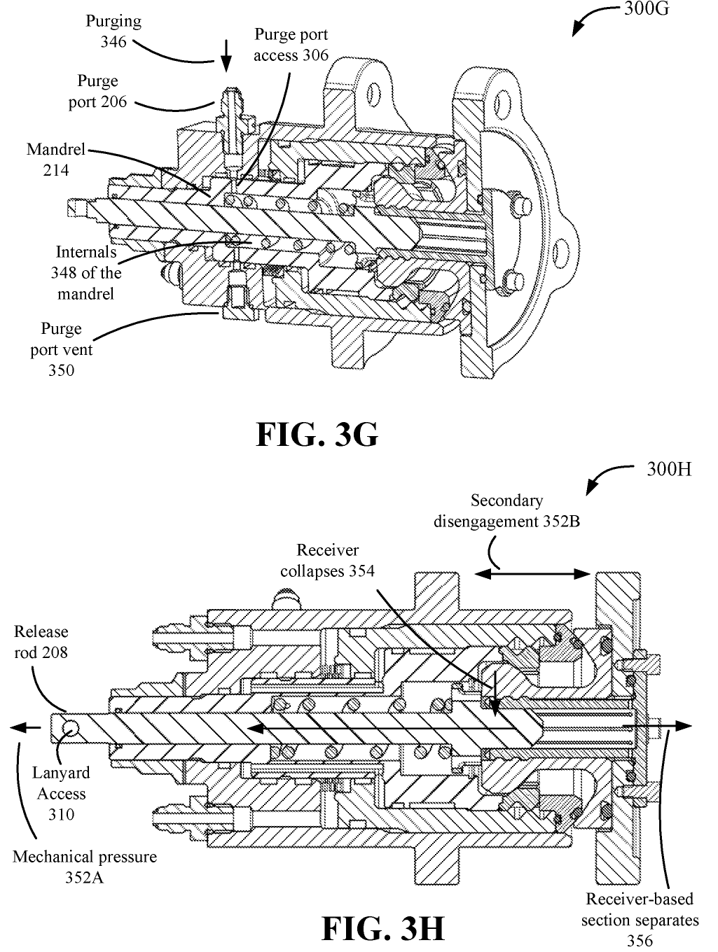

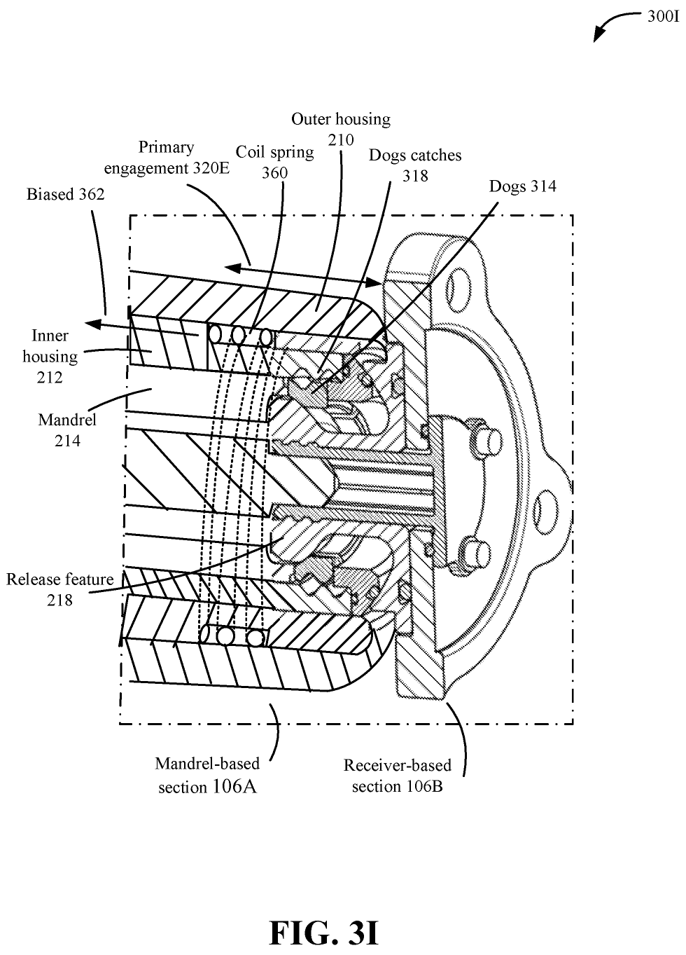

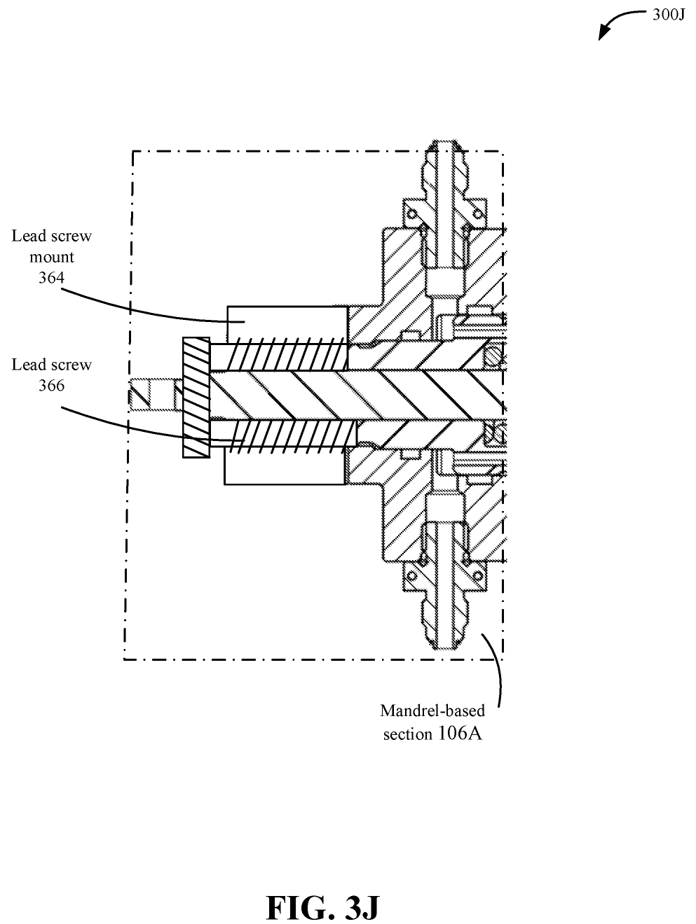

The mandrel-based section 106A may include a release rod 208 which may be through an outer housing 210 of the mandrel-based section 106A and through a mandrel (detailed further in connection with FIGS. 2C-3H) which may be within the mandrel-based section 106A. The release rod 208 may be biased to be in a locked position with a release feature of the receiver 216, as also detailed further with respect to one or more of FIGS. 2C-3H. The release rod 208 may be configured for the mechanical-pressure secondary engagement and disengagement between the receiver-based section 1006B and the mandrel-based section 106A, and through the receiver.

FIG. 2A also illustrates that a purge port 206 may be provided on the mandrel-based section 106A. The purge port 206 may be configured to support a purge through internals 348 (in FIGS. 3B and 3G) of a mandrel which may be within the mandrel-based section 106A. As the mandrel-supported or based URM may be used in areas near cryogenic activities, the internals 348 of the mandrel may need venting. The media for locking or unlocking may also be different than media used for purging. In addition, the media for locking, unlocking, or purging may be different than media in a transfer application using the system 100 in FIG. 1. For example, liquid H₂ may be flowing in the areas and there may be a possibility for condensation and icing within the areas. The purge port 206 may be used with a gas source, such as gaseous He, for purging the internals 348 of at least the mandrel. The media used for purging may be distinct from the media used for the lock ports or the unlock ports. FIG. 2A also illustrates that the mandrel-based section 106A may include an outer housing 210 through which one or more of the lock ports 202, the unlock ports 204, and the purge ports 206 may be provided.

FIG. 2B illustrates further aspects 200B of a mandrel-supported or based release mechanism, in accordance with a further non-limiting aspect of the present disclosure. The further aspects 200B includes illustration of the mandrel-supported or based release mechanism from a receiver’s perspective. Portion or all of the base 220B of the receiver-based section 106B may be located behind the launch vehicle feature 110A, 110B. This may be to protect internal aspects of the receiver-based section 106B after separation from the mandrel-based section 106A for a space mission. As illustrated with respect to FIG. 2A, the further aspects 200B include connection features 220C to allow the coupling between a base 220B of receiver-based section 106B with the launch vehicle feature 110A, 110B and between a base 220A of the mandrel-based section 106A with the ground feature 108A.

FIG. 2B also illustrates the at least one lock port 202 which may be configured to receive a media for the pneumatic-pressure primary engagement and the at least one unlock port 204 which may be configured to receive a media for the pneumatic-pressure primary disengagement. In addition, FIG. 2B also illustrates the purge port 206 which may be provided on the mandrel-based section 106A and which may be configured to support a purge through 348 (in FIGS. 3B and 3G) of a mandrel which may be within the mandrel-based section 106A. FIG. 2B also illustrates a base 218A of a release feature which may be used, in part, for the pneumatic-pressure primary engagement and disengagement and for the mechanical-pressure secondary engagement and disengagement, and which is addressed in detail in connection with one or more of FIGS. 2D-3H.

FIG. 2C illustrates cross-section aspects 200C of a receiver-based section, in accordance with a further non-limiting aspect of the present disclosure. The mandrel-based section 106A may include a mandrel 214. The mandrel 214 may extend through most of the mandrel-based section 106A, from a top of a release rod 208 to a mouth 214A. The mandrel 214 may include a pass-through for the release rod 208, as well as support for an inner housing 212. The lock port 202 may be configured to receive a media for the pneumatic-pressure primary engagement. As illustrated, the lock port 202 may access the inner housing 212 to displace the inner housing 212 based in part on the media for the pneumatic-pressure primary engagement. While the inner housing 212 may receive media for the pneumatic-pressure primary engagement and disengagement, the outer housing 210 may retain the media to the inner housing 212.

FIG. 2C also illustrates that the release rod 208 of the mandrel-based section 106A may pass through the outer housing 210 and the mandrel 214 of the mandrel-based section 106A. The release rod 208 may be configured for the mechanical-pressure secondary engagement by being in a locked position with a release feature of the receiver 216. In one example, the release rod 208 may be biased, by a release rod biasing feature 312 (also in FIG. 3B), to also be in the locked position with the release feature of the receiver 216. This may be part of the mechanical-pressure secondary engagement in the mandrel-supported or based release mechanism. The release rod biasing feature 312 may be a spring, in one example. In some examples, the biasing feature 312 may be accomplished through use of shear pins, which may shear when the release rod 208 is pulled, for instance. The release rod 208 may also be configured for a mechanical-pressure secondary disengagement between the receiver-based section 1006B and the mandrel-based section 106A, and through the receiver 216. For example, the release rod 208 may be pulled against the release rod biasing feature 312 to be released from the release feature of the receiver 216, which is detailed further in connection with at least FIG. 3H.

FIG. 2D illustrates cross-section aspects 200D of a mandrel-based section, in accordance with a further non-limiting aspect of the present disclosure. FIG. 2D illustrates details of the receiver 216 of the receiver-based section 106B. The receiver 216 may include a release feature 218 which may be a collet and may include collet segments or fingers. In one example, the release feature 218 is able to capture and retain a knob 208A (in FIG. 2C) at an end of the release rod 208. The release feature 218 may be formed from copper-beryllium or a composite of copper-beryllium. In some examples, copper-beryllium may be used at least because of its non-sparking properties. The receiver 216 may be able to apply circumferential pressure on the release feature 218 to allow the release feature 218 to capture and retain the knob 208A of the release rod 208 till at least the circumferential pressure is removed. The release rod 208 may be biased to be in a locked position with the knob 208A within the release feature 218 of the receiver 216. In this manner, there is biasing in the mandrel-supported or based URM to maintain the engagement between sections of the mandrel-supported or based URM to support transfer of media.

FIG. 3A illustrates aspects 300A of a mandrel in a mandrel-supported or based release mechanism, in accordance with a further non-limiting aspect of the present disclosure. As illustrated, a mandrel 214 may include a center pass-through having the release rod 208. The mandrel 214 may include access for unlocking and purging using, for example, the unlock port access 304 and the purge port access 306. The unlock port access 304 allows media to access the inner housing 212 which is within the mandrel 214 from the unlock port 204. Similarly, the purge port access 306 may allow media for purging, from the purge port 206, to access internals 348 (in FIG. 3G) of the mandrel 214. The internals 348 may include the release rod biasing feature 312 associated with the release rod 208.

In addition, the mandrel 214 may include an unlock media channel 334 (also in FIG. 3F). The unlock media channel 334 may be within the mandrel 214 and may not be externally visible. The unlock media channel 334 may be multiple channels which may be between the unlock port access 304 of the mandrel 214 and an inner housing access 212 of the mandrel 214. The unlock port access 304 receives media for unlocking from the unlock port 204. The unlock media channel 334 allows the media to flow through. The inner housing access 308 allows the media from the unlock media channel 334 to flow out and into areas between the inner housing 212 and the mandrel 214. At a time for primary disengagement, the media in the areas between the inner housing 212 and the mandrel 214 may cause the inner housing to be pushed away from the receiver 216 and may support or allow primary disengagement of the release rod 208 without need for a mechanical-pressure secondary disengagement, as detailed further in connection with FIG. 3F.

FIG. 3A also illustrates that the mandrel 214 may include dogs access 302 for dogs 314 (in FIG. 3B) which may be used to provide the circumferential pressure to the receiver 216. The circumferential pressure from the dogs 314 may be transferred to the release feature 218, to support or allow capture and retention of the knob 208A of the release rod 208. The dogs 314 may be between the receiver 216 and the inner housing 212, and through the mandrel 214. FIG. 3A also illustrates that the release rod 208 may include a lanyard access 310 for access and for asserting a predetermined pull-force on the release rod 208. The predetermined pull-force may be at least more than a biasing force asserted by the release rod biasing feature 312 and, additionally, more than a circumferential pressure transferred from the dogs 314 to the knob 208A of the release rod 208. The predetermined pull-force may be sufficient to dislodge the knob 208A from the release feature 218 to allow, in part, the mechanical-pressure secondary disengagement, described further in connection with at least FIG. 3H.

FIG. 3B illustrates aspects 300B of a biasing feature used to allow or support a bias in the release rod to be in a locked position with a release feature in the mandrel-supported or based release mechanism, in accordance with a further non-limiting aspect of the present disclosure. The release rod biasing feature 312 may be associated with a release rod base 208B and with a mid-portion of the release rod 208. The release rod biasing feature 312 may be able to allow the release rod 208 to be biased in a locked position in which the knob 208A of the release rod is within the release feature 218 of the receiver 216. FIG. 3B also illustrates the internals 348 of the mandrel as the release rod 208 is within the mandrel 214 when the mandrel is made up for the mandrel-supported or based URM. The internals 348 are subject to the purging from media applied to the purge port 206 and which passes through the purge port access 306 of the mandrel.

FIG. 3B also illustrates the dogs 314 which may be used to apply the circumferential pressure on the release feature 218, through the dogs access 302, of the mandrel 214. The dogs 314 may be associated with dog catches 318 (in FIG. 3E) of the inner housing 212. The dogs 314 being within the dog catches 318 may allow one or more of the release rod 208, the inner housing 212, the release feature 218, or the receiver 216 to be in an unlocked position at least by virtue of the dogs 314 being unable to apply the circumferential pressure on the receiver 216 and, by extension, the release feature 218. In some examples, the shape of the dogs 314 may be selected to allow or support a fast change of state from engaged to disengaged within the mandrel-supported or based URM. In some examples, a fast change of state may be because the shape of the dogs 314 allow for a short travel distance. For instance, having at least two bumps may reduce travel between components of the mandrel-supported or based URM by half to get from an engaged state to a disengaged state.

In some examples, the dogs 314, which may be between the receiver 216 and the inner housing 212 and through the mandrel 214, may include a double bump shape to allow for a predetermined change of state associated with one or more of the mechanical or pneumatic-pressure primary engagement, the pneumatic-pressure primary disengagement, or a mechanical-pressure secondary engagement and disengagement between the first section and the second section. The mandrel 214 may support a movement, caused by the pneumatic-pressure primary disengagement, for instance, which may be about half a height of the mandrel 214 for the change of state to occur. This may represent a fast actuation which may be crucial for T-0 (which may be a launch terminal countdown). In the launch terminal countdown, the mandrel-supported or based URM may need to disengage once the engines are started and before launch occurs.

Without the circumferential pressure acting on the release feature 218 to allow capture and retention of the knob 208A of the release rod 208, the mandrel-supported or based URM may be wholly in an unlocked position, with the sections of the mandrel-supported or based URM separating or separated. FIG. 3B also illustrates that the dogs 314 may be free-floating and not fixed within the mandrel-supported or based URM. The dogs 314 may be shaped to fit through the dogs access 302, to engage with the dog catches 318, and the move into or away from the dog catches 318 based in part on inner housing movement 330 or receiver biasing 342 (in FIG. 3E, for instance).

FIG. 3C illustrates aspects 300C of a release rod in a mandrel-supported or based release mechanism, in accordance with a further non-limiting aspect of the present disclosure. The release rod 208 may include a release rod base 208B to prevent the release rod from extending too far into the receiver 216. For example, as the release rod 208 is biased to be in a locked position and may be subject to mechanical-pressure secondary disengagement, the release rod 208 may return back to the locked position once released. As the mandrel-supported or based URM is reusable, the return of the release rod 208 should not damage the receiver 216 by an unintended extension, for instance.

FIG. 3D illustrates aspects 300D of a release feature in a mandrel-supported or based release mechanism, in accordance with a further non-limiting aspect of the present disclosure. FIG. 3D illustrates detailed aspects of the release feature 218 and, particularly, collet segments if the release feature 218 is a collet, in one example. The collet segments may hold together the knob 208A of the release rod 208 so long as there is circumferential pressure from the dogs 314 asserted on the collet segments. The collet segments may be shaped or may have an interior profile and an exterior profile. The interior profile may be such that there is a predetermined pressure transferred to the knob 208A of the release rod 208 to support or allow capture and retention of the release rod 208. The exterior profile is so that the collet segments fit within the receiver 216 and so that the receiver can fully transfer the circumferential pressure from the dogs 314. Further, as illustrated, in part, in FIG. 2B, the release feature 218 may have a base 218A which may extend outside the receiver-based section 106B and which may be coupled to a base 220B of the receiver-based section 106B.

FIG. 3E illustrates aspects 300E of a pneumatic-pressure primary engagement and a mechanical-pressure secondary engagement in a mandrel-supported or based release mechanism, in accordance with a further non-limiting aspect of the present disclosure. In operation, sections 106A, 106B may be brought together to support or allow a knob 208A of the release rod 208 to be caught and to be retained within the release feature 218 of the receiver 216. As the release rod 208 is biased in a locked position 326, the release rod 208 is able to remain in position with the knob 208A extended for capture and retention within the release feature 218. This may be part of the mechanical pressure 328A used for the secondary engagement 328B. The mechanical pressure 328A based secondary engagement 328B is generally referred to as a mechanical-pressure secondary engagement. FIG. 3E also illustrates that the mandrel-supported or based URM may include one or more seals 322 to retain mechanical interfaces where intended between the aspects 200-300H of the mandrel-supported or based URM described throughout herein, and to retain media to where intended in the mandrel-supported or based URM during locking and unlocking of the mandrel-supported or based URM.

For example, as the secondary engagement 328B occurs through a mouth 214A of the mandrel 214, the mechanical pressure 328A used for the secondary engagement 328B is supported or allowed by the mandrel 214. In the example, the mandrel 214 supports or allows the mechanical pressure 328A to cause secondary engagement 328B at least because the release feature 218 and the receiver 216 are allowed into mandrel 214 through the mouth 214A of the mandrel 214, illustrated in at least FIG. 2C. In addition, the mechanical pressure 328A caused secondary engagement 328B is between the sections 106A, 106B of the mandrel-supported or based URM, and through the receiver 216. Also, as the mechanical-pressure secondary engagement does not cause a locked position as yet between the sections 106A, 106B of the mandrel-supported or based URM, the engagement caused is a secondary engagement.

Once the mechanical-pressure secondary engagement has occurred, the dogs 314 may remain within the dog catches 318 till a media for locking is applied as part of the pneumatic pressure 320A to the lock ports 202. In one example, the secondary engagement 328B may support or allow a locked position 324 for some aspects of the mandrel-supported or based URM (such as by allowing the release rod 208 to be extended and to receive the receiver 216) but may not include a locked position for the mandrel-supported or based URM. In one example, it is the primary engagement 320B which provides the locked position for the mandrel-supported or based URM, by the pneumatic pressure 320A to the lock ports 202.

The lock port 202 may be configured to receive media for the pneumatic-pressure primary engagement. The media for locking may be applied from a media source. For example, once the mechanical-pressure secondary engagement has occurred, pneumatic pressure 320A through the lock ports 202 may cause an inner housing movement 330 to the inner housing 212. The inner housing movement 330 may cause the inner housing 212 to be pushed towards the receiver 216. The inner housing movement 330 may dislodge the dogs 314 from the dog catches 318 and through the dogs access 302 of the mandrel 214. The dogs 314, once dislodged, may be subject to a circumferential pressure which may be, in part, from the inner housing passing over the dogs 314.

The dogs 314 may, in turn, transfer the circumferential pressure to the receiver 216. The receiver 216 may transfer the circumferential pressure to the release feature 218 to cause the receiver biasing 342 of the release feature 218. The receiver biasing 342 causes a locked position for one or more of the release rod 208, the inner housing 212, the release feature 218, or the receiver 216. At least a locked position 324 for the release feature 218 and the release rod 208 is illustrated in FIG. 3E, with the release rod biased 326 in a locked position by being within the release feature 218. A locked position for the mandrel-supported or based URM may be further supported or allowed by the dogs 314 applying the receiver biasing 342 to the release feature 218 with the release road biased 326 in the locked position. The mandrel 214, by allowing such actions from the application of the pneumatic pressure 320A, also allows or supports the primary engagement 320B between the sections 106A, 106B of the mandrel-supported or based URM, and through the receiver 216. The pneumatic pressure 320A based primary engagement 320B may be generally referred to herein as pneumatic-pressure primary engagement.

The sections 106A, 106B of the mandrel-supported or based URM are in also in the locked position as a result of the pneumatic-pressure primary engagement and the mechanical-pressure secondary engagement. FIG. 3E also illustrates that a threaded retainer 332 may be used to remove loading on the mandrel-supported or based URM in the locked position for the sections 106A, 106B. The threaded retainer 332 may be used to cause preloading to the threaded retainer, once the sections 106A, 106B of the mandrel-supported or based URM. The dogs 314 herein may be in the locked position with the release feature 218 but may be within the inner housing in an unlocked position. The one or more dog catches 318 may be to receive the dogs 314, in the unlocked position for the release feature 218 and for the sections 106A, 106B of the mandrel-supported or based URM.

FIG. 3F illustrates aspects 300F of a pneumatic-pressure primary disengagement in a mandrel-supported or based release mechanism, in accordance with a further non-limiting aspect of the present disclosure. The sections 106A, 106B of the mandrel-supported or based URM may be separated or disengaged after the media transfer is completed, as part of a routine transfer. The separation or disengagement of the sections 106A, 106B, after the media transfer is completed and as part of a routine transfer, may be referred to as the pneumatic-pressure primary disengagement.

In operation, to perform the separation or disengagement of the sections 106A, 106B, media for unlocking may be applied to the unlock port 204. The pneumatic-pressure primary disengagement may be performed by initially removing preloading to the threaded retainer 332, followed by the pneumatic pressure 320C to the unlock ports 204. The removal of preloading may be a case when the separation or disengagement in the mandrel-supported or based URM needs to be controlled and slowed. This may be related to separation or disengagement from an on-going service associated with the umbilical panels. In some examples, for the mandrel-supported or based URM, the threaded retainer 332 may not be used for control or slowing the separation or disengagement as an intent of the mandrel-supported or based URM is to allow for fast actuation or to allow fast disengagement. Disengagement may occur by applying the pneumatic pressure to the unlock ports 204 without removing the preload, in some examples. There may be sufficient piston area to receive the pneumatic pressure to an extent to overcome any friction generated by the preload, in some examples. The unlock port 204 may be configured to receive the media for unlocking and the pneumatic-pressure primary disengagement. The media may be applied as a pneumatic pressure 320C, for unlocking, from a media source which may be a same media source or which may be different media source from the media source for locking, described in connection with at least FIG. 3E. The media may pass through the unlock port access 304 (in FIG. 3A), through the unlock media channel 334, and may enter the inner housing space 336 through the inner housing access 308 (in FIG. 3A).

The media in the inner housing space 336 may apply pressure to cause an inner housing movement 338 in the inner housing 212. The inner housing movement 338 aligns the dogs catches 318 with the dogs access 302 of the mandrel 214 and with the dogs 314. The dogs 314 release 340 to the dog catches 318 through the dogs access 302. With the dogs 314 released, the circumferential pressure through the release feature 218 is removed. The removal of the circumferential pressure may be so that the receiver 216 removes 344 biasing of the release feature 218. With the biasing removed, the release feature 218 may release the knob 208A of the release rod 208 to cause the primary disengagement 320D between the sections 106A, 106B of the mandrel-supported or based URM. As the mandrel allows the alignment and release 340 of the dogs 314, the mandrel supports or allows the pneumatic pressure 320C to cause primary disengagement 320D between the sections 106A, 106B of the mandrel-supported or based URM.

FIG. 3G illustrates aspects 300G purging performed in a mandrel-supported or based release mechanism, in accordance with a further non-limiting aspect of the present disclosure. In operation, to perform purging 346 for the mandrel-supported or based URM. Media for the purging 346 may be applied to a purge port 206 from a media source which may be a same or a different media source from the media source for locking or unlocking, described in connection with at least FIGS. 3E and 3F. The media may pass through the purge port access 306 (in FIG. 3A) and may enter the internals 348 of the mandrel 214. A purge port vent 350 may be opened to allow passage of the media applied for the purging 346 at the purge port 206.

FIG. 3H illustrates aspects 300H of mechanical-pressure secondary disengagement in a mandrel-supported or based release mechanism, in accordance with a further non-limiting aspect of the present disclosure. The sections 106A, 106B of the mandrel-supported or based URM may be separated or disengaged before the media transfer is completed, as part of an emergency. The separation or disengagement of the sections 106A, 106B, before the media transfer is completed and as part of the emergency, may be referred to as the mechanical-pressure secondary disengagement.

In operation, to perform the separation or disengagement of the sections 106A, 106B, the release rod 208 may be pulled or subject to other mechanical pressure 352A to cause the release rod 208 to be in an unlocked position. The mechanical pressure 352A may be using a lanyard through the lanyard access 310 (also in FIG. 3A) or other parts of the release rod 208, which may be accessed for this purpose. As discussed in connection with FIG. 3A, the mechanical pressure 352A may be a predetermined pull-force on the release rod 208. The predetermined pull-force may be at least more than a biasing force asserted by the release rod biasing feature 312 and, additionally, more than a circumferential pressure transferred from the dogs 314 to the knob 208A of the release rod 208. The predetermined pull-force may be sufficient to dislodge the knob 208A from the release feature 218 to allow, in part, the receiver 216 to collapse. As the receiver 216 collapses 354, a secondary disengagement 352B is achieved without a media through the unlock port 204. This at least represents the mechanical-pressure secondary disengagement in the mandrel-supported or based release mechanism and the receiver-based section 106B separates 356 from the mandrel-based section 106A.

The media in the inner housing space 336 may apply pressure to cause an inner housing movement 338 in the inner housing 212. The inner housing movement 338 aligns the dogs catches 318 with the dogs access 302 of the mandrel 214 and with the dogs 314. The dogs 314 release 340 to the dog catches 318 through the dogs access 302. With the dogs 314 released, the circumferential pressure through the release feature 218 is removed. The removal of the circumferential pressure may be so that the receiver 216 removes 344 biasing of the release feature 218. With the biasing removed, the release feature 218 may release the knob 208A of the release rod 208 to cause the primary disengagement 320D between the sections 106A, 106B of the mandrel-supported or based URM. As the mandrel allows the alignment and release 340 of the dogs 314, the mandrel supports or allows the pneumatic pressure 320C to cause primary disengagement 320D between the sections 106A, 106B of the mandrel-supported or based URM.

Therefore, the release rod 208 may be configured for the mechanical-pressure secondary engagement (as described in connection with FIG. 3E) and disengagement (as described in connection with FIG. 3H) between the first section and the second section, and through the receiver. Further, as the mechanical pressure for the mechanical-pressure secondary disengagement is performed as part of an emergency, it may be performed when the pneumatic-pressure primary engagement and the mechanical-pressure primary engagement are still active, partly removed, or in the process of being removed. The mechanical pressure may be at least more than a biasing force asserted by the release rod biasing feature 312 and, additionally, more than a circumferential pressure transferred from the dogs 314 to the knob 208A of the release rod 208. The mechanical pressure may be higher than a pressure associated with the pneumatic-pressure primary engagement to support or allow the mechanical-pressure secondary disengagement. Although, in one example, at least the pneumatic-pressure primary engagement may be released or reduced to also reduce the mechanical pressure required for the mechanical-pressure secondary disengagement.

FIG. 3I illustrates aspects 300I of mechanical-pressure primary engagement in a mandrel-supported or based release mechanism, in accordance with a further non-limiting aspect of the present disclosure. In some examples, the primary engagement may be mechanical. For instance, there may a bias towards engagement for the mandrel-based section 106A and the receiver-based section 106B. A coil spring 360 may be used between the inner housing 212 having the dog catches 318 and the outer housing 210, and may be supported by mandrel 214. The coil spring 360 may allow the use of pneumatic pressure only for the primary disengagement 320D, described in connection with FIG. 3F. For instance, the coil spring 360 may be biased to keep the dog catches 318 away from the dogs 314. The dogs 314 may be pressed against the release feature 218, which allows the mechanical-pressure primary engagement 320E till pressure is applied to the unlock ports 204, as in FIG. 3F to release the mandrel-based section 106A and the receiver-based section 106B, as part of a primary disengagement. In addition, with the mechanical-pressure primary engagement 320E removes from a need for the lock ports 202 to cause a primary engagement 320B.

FIG. 3J illustrates aspects 300J of threaded retainer in a mandrel-supported or based release mechanism, in accordance with a further non-limiting aspect of the present disclosure. As illustrated, instead of the threaded retainer for preloading illustrated as a nut in one or more of FIGS. 2A-3H, the threaded retainer may be a lead screw 366 may be screwed into a lead screw mount 364 which may be part of the mandrel-based section 106A. For example, the lead screw mount 364 may be an integral part of the outer housing 210 but may allow transfer of loading from the mandrel 214 or components having loading within the mandrel-based section 106A.

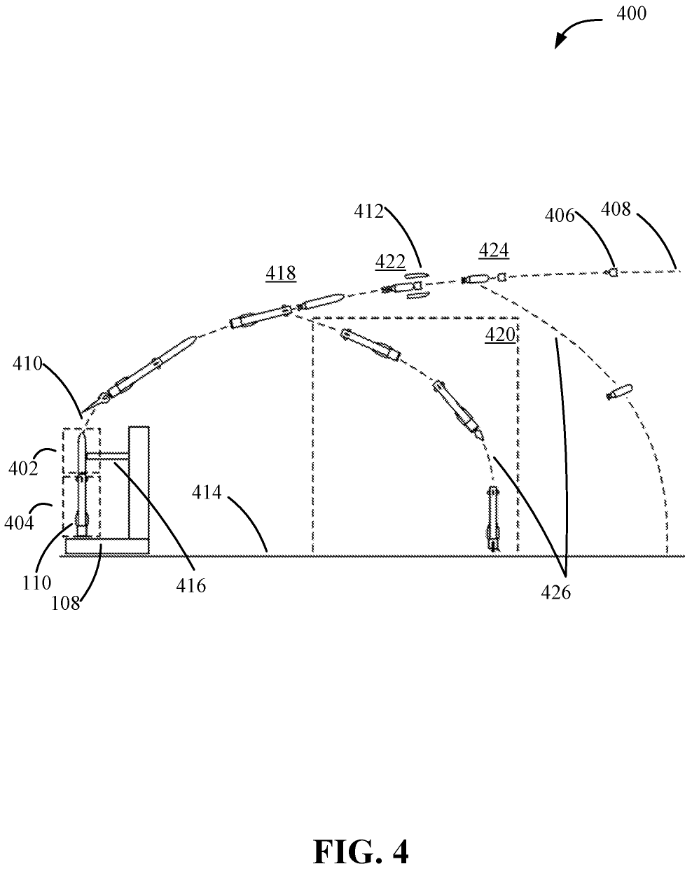

FIG. 4 illustrates an example space mission 400 having components benefiting from the mandrel-supported or based release mechanism, in accordance with a further non-limiting aspect of the present disclosure. A launch vehicle 110 may include at least the upper stage 402 with the payload module (and the upper stage propulsion module in FIG. 1), which may be on top of a lower stage (or first stage) propulsion module 404. A launch vehicle feature 110A, 110B (in FIG. 1) may be a payload module, the upper stage 402, or the lower stage propulsion module 404, which may be subject to connections for media transfer and which may benefit from the mandrel-supported or based release mechanism herein. In the example of FIG. 4, the component may be interchangeably referenced as a payload module. In another example, the components may be the upper stage propulsion module. The space mission 400 may be for placement or guidance of payload 406 to a suitable orbit 408. In one example, there may be multiple payloads for different intended orbits.

The launch vehicle 110 may travel through an initial trajectory or flight path 410 for a period of time. The payload module having the one or more payload 406 may include fairings 412 to enclose the payload 406. The fairings 412 may have sections which may be subject to separation to allow release of the one or more payload 406. In one example, a payload module or the payload 406 may be one which, without limitations, docks with a space station or performs space-related investigations, prior to re-entry and landing back on Earth’s surface 414 or without returning back to the Earth’s surface 414, as part of the space mission 400.

There may be maneuvers associated with components of the launch vehicle 110. There may be pre-flight activities to be performed before and/or when the launch vehicle 110 is prepared on a launchpad 108. The pre-flight activities may include media transfer and may use connections through umbilical 416 having umbilical panels and mandrel-supported or based release mechanism herein. A payload 406 may include satellites and other components. Such satellites or other components may be loaded into dispensers or other deployment aspects of the payload module.

The space mission 400 may include a liftoff of the payload module from the launchpad 108. After liftoff and after an initial time span, the launch vehicle 110 may proceed in the initial trajectory or flight path 410 as part of an ascent phase. After ascending for a time span, a first stage separation 418 may occur. In the first stage separation 418, a payload module may separate from a lower stage propulsion module 404. After the first stage separation 418, the lower stage propulsion module 404, which may proceed along a different trajectory or flight path 426 and may perform a reorientation maneuver, followed by a landing burn, and a landing, which are all generally represented by a block 420 representation in FIG. 4.

A fairing jettison phase 422 may occur at a time which may be just prior to, during, or just after the first stage separation 418. While the fairing jettison phase 422 may occur with respect to the lower stage propulsion module 404, any dispenser associated with the lower stage propulsion module 404 may also be caused to eject any component for telemetry at this phase or between this phase and the prior first stage separation 418. Such a component may include an analog to digital converter (ADC) and other components. This may be so that the ADC and the other components may have a same or similar speed and trajectory (e.g., velocity) as lower stage propulsion module 404 and may be a parallel trajectory relative to the illustrated trajectory of the lower stage propulsion module 404.

The payload 406 may separate from the payload module in a payload or second separation stage 424. The payload 406 may proceed in micro-gravity (also referred to by the approximation “zero-gravity”). For certain trajectories, there may be more time required to reach a suitable orbit 408 to continue docking with a space station or performing other space-related investigations and prior to any potential re-entry. The space mission 400 may end when payload 406 is set in orbit or returns to the Earth’s surface 414 at a suitable time. A payload module may carry equipment to and from space, samples to space, samples from space, or may be a crew module for crew or passengers.

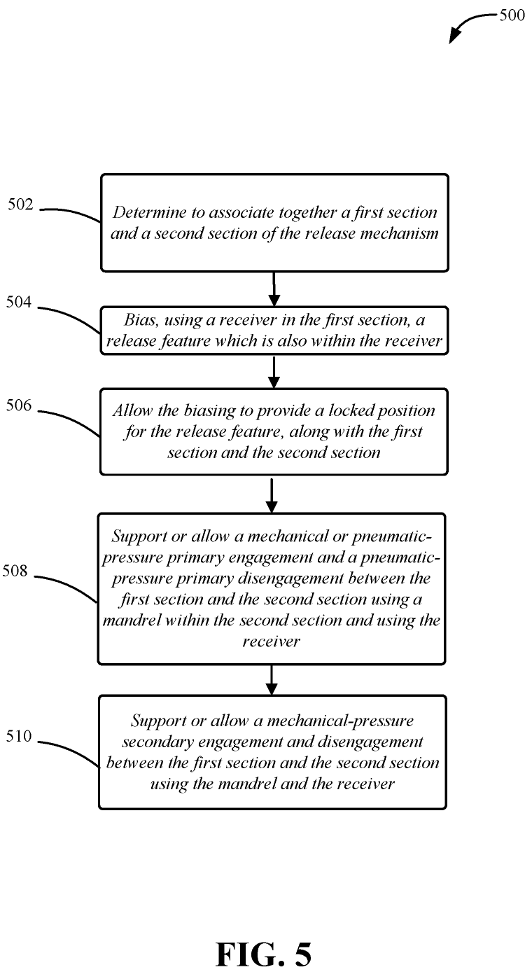

FIG. 5 illustrates a method 500 associated with a system used for mandrel-supported or based release mechanism, in accordance with a further non-limiting aspect of the present disclosure. The method 500 may include a step to determine 502 to associate together a first section and a second section of the release mechanism. The method 500 may include a step to bias 504, using a receiver in the first section, a release feature which is also within the receiver. The method 500 may include a step to allow 506 the biasing to provide a locked position for the release feature, along with the first section and the second section. The method 500 may include a step to support or allow 508 a mechanical or pneumatic-pressure primary engagement and a pneumatic-pressure primary disengagement between the first section and the second section using a mandrel within the second section and using the receiver. The method 500 may include a step to support or allow 510 a mechanical-pressure secondary engagement and disengagement between the first section and the second section using the mandrel and the receiver.

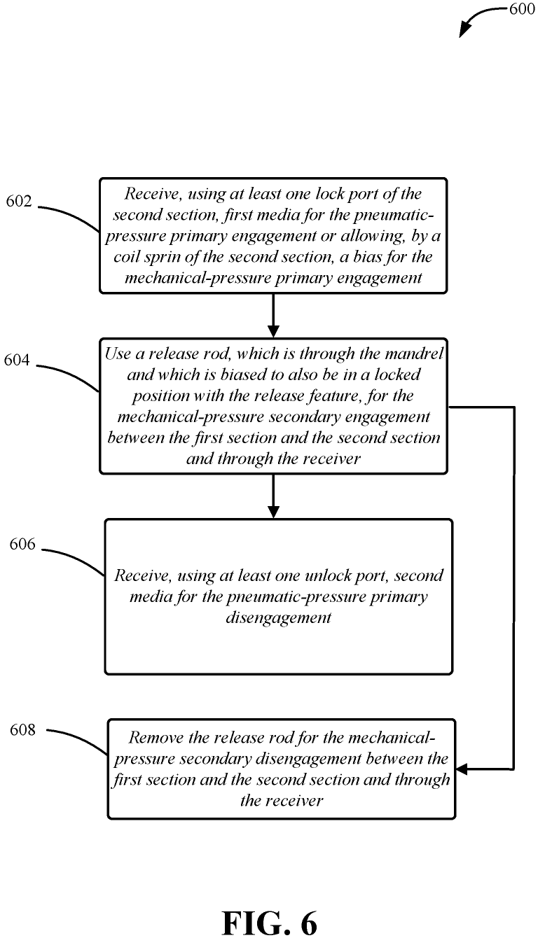

FIG. 6 illustrates a further method 600 associated with a system used for mandrel-supported or based release mechanism, in accordance with a further non-limiting aspect of the present disclosure. The method 600 in FIG. 6 may be used with or separately from the method 500 in FIG. 5. For example, the method 600 in FIG. 6 may use a release rod with one or more of the mechanical-pressure primary engagement, the pneumatic-pressure primary engagement, the pneumatic-pressure disengagement, the mechanical-pressure secondary engagement, or the pneumatic-pressure disengagement herein. For example, the method 600 may include a step to receive 602, using at least one lock port of the second section, first media for the pneumatic-pressure primary engagement. The method 600 may include an alternate in the step 602 to allow, by a coil spring of the second section, a bias for the mechanical-pressure primary engagement.

The method 600 may include a step to use 604 a release rod, which is through the mandrel and which is biased to also be in a locked position with the release feature, for the mechanical-pressure secondary engagement between the first section and the second section, and through the receiver, as described in at least step 510 in FIG. 5. The order of the steps may be changed, with the release rod used before the pneumatic-pressure primary engagement. The method 600 may include a step to receive 606, using at least one unlock port, second media for the pneumatic-pressure primary disengagement. The step 606 may follow as a routine transfer of media being completed. The method 600 may include a step to remove 608 the release rod for the mechanical-pressure secondary disengagement between the first section and the second section, and through the receiver. The step 608 may follow as an emergency when the routine transfer is interrupted, incomplete, or when the step 606 for the second media to perform the pneumatic-pressure primary disengagement has failed.

The methods 500, 600 may include a further step or a sub-step to determine a ground feature having the second section to be associated with a launch vehicle having the first section. The methods 500, 600 may include a further step or a sub-step to associate together the first section and the second section based in part on the locked position for the release feature, along with the first section and the second section. The methods 500, 600 may include a further step or a sub-step to use a threaded retainer to remove loading on the release mechanism in the locked position for the first section and the second section. The methods 500, 600 may include a further step or a sub-step to receive, using a purge port, a third media for a purge through internals of the mandrel.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize or be able to ascertain using no more than routine experimentation, many equivalents to the various aspects of the disclosure described herein upon review of this specification. Thus, the disclosure is not limited by the description of the various aspects, but rather by the claims.

What is claimed is:

1. A system for release mechanism, the system comprising:
a first section and a second section;
a receiver in the first section and configured to bias a release feature, which is within the receiver, to be in a locked position along with the first section and the second section; and
a mandrel within the second section configured to support or allow a mechanical or pneumatic-pressure primary engagement and a pneumatic-pressure primary disengagement between the first section and the second section and through the receiver, and configured to support or allow a mechanical-pressure secondary engagement and disengagement between the first section and the second section and through the receiver.

2. The system of claim 1, further comprising:
a launch vehicle to comprise the first section; and
a ground feature to comprise the second section.

3. The system of claim 1, further comprising:
a threaded retainer configured to remove loading on the release mechanism in the locked position for the first section and the second section.

4. The system of claim 1, further comprising:
at least one lock port configured to receive first media for the pneumatic-pressure primary engagement or a coil spring to allow a bias for the mechanical-pressure primary engagement; and
at least one unlock port configured to receive second media for the pneumatic-pressure primary disengagement.

5. The system of claim 1, further comprising:
a release rod through the mandrel and biased to also be in the locked position with the release feature, the release rod configured for the mechanical-pressure secondary engagement and disengagement between the first section and the second section and through the receiver.

6. The system of claim 1, further comprising:
an inner housing to receive media for the pneumatic-pressure primary engagement and disengagement or to support a coil spring for the mechanical-pressure primary engagement; and
an outer housing to retain the media to the inner housing.

7. The system of claim 6, further comprising:
one or more dogs between the receiver and the inner housing and through the mandrel, the one or more dogs to also be in the locked position with the release feature; and
one or more dog catches within the inner housing, the one or more dog catches to receive the one or more dogs in an unlocked position for the release feature, the first section, and the second section.

8. The system of claim 1, further comprising:
a purge port configured to support a purge through internals of the mandrel; or
one or more dogs between the receiver and the inner housing and through the mandrel, the one or more dogs comprising a double bump shape to allow for a predetermined change of state
associated with one or more of the mechanical or pneumatic-pressure primary engagement, the pneumatic-pressure primary disengagement, or a mechanical-pressure secondary engagement and disengagement between the first section and the second section, wherein the mandrel supports a movement, caused at least by the pneumatic-pressure primary disengagement, which is about half a height of the mandrel for the change of state to occur.

9. The system of claim 1, wherein a first pressure associated with the mechanical-pressure secondary disengagement is higher than one or more of a second pressure associated with the mechanical or pneumatic-pressure primary engagement or the mechanical-pressure secondary engagement.

10. A mandrel-based section of an umbilical release mechanism (URM), the mandrel-based section comprising a mandrel configured to support or allow a mechanical or pneumatic-pressure primary engagement and a pneumatic-pressure primary disengagement between a receiver-based section and the mandrel-based section and through a receiver of the receiver-based section, and configured to support or allow a mechanical-pressure secondary engagement and disengagement between the receiver-based section and the mandrel-based section and through the receiver.

11. The mandrel-based section of claim 10, further comprising:
a threaded retainer configured to remove loading on the URM in a locked position for the receiver-based section and the mandrel-based section.

12. The mandrel-based section of claim 10, further comprising:
at least one lock port configured to receive first media for the pneumatic-pressure primary engagement or at least one a coil spring to allow a bias for the mechanical-pressure primary engagement;
at least one unlock port configured to receive second media for the pneumatic-pressure primary disengagement; and
a purge port configured to support a purge through internals of the mandrel.

13. The mandrel-based section of claim 10, further comprising:
a release rod through the mandrel and biased to be in a locked position with a release feature of the receiver, the release rod configured for the mechanical-pressure secondary engagement and disengagement between the receiver-based section and the mandrel-based section and through the receiver.

14. The mandrel-based section of claim 10, further comprising
an inner housing to receive media for the pneumatic-pressure primary engagement and disengagement or to support a coil spring for the mechanical-pressure primary engagement; and
an outer housing to retain the media to the inner housing.

15. The mandrel-based section of claim 14, further comprising
one or more dogs between the receiver and the inner housing and through the mandrel, the one or more dogs to be in a locked position with the release feature; and
one or more dog catches within the inner housing, the one or more dog catches to receive the one or more dogs in an unlocked position for the release feature, the receiver-based section, and the mandrel-based section.

16. A method for a release mechanism, the method comprising:
determining to associate together a first section and a second section of the release mechanism;
biasing, using a receiver in the first section, a release feature which is also within the receiver, wherein the biasing provides a locked position for the release feature, along with the first section and the second section;
supporting or allowing a mechanical or pneumatic-pressure primary engagement and a pneumatic-pressure primary disengagement between the first section and the second section using a mandrel within the second section and using the receiver; and
supporting or allowing a mechanical-pressure secondary engagement and disengagement between the first section and the second section using the mandrel and the receiver.

17. The method of claim 16, further comprising:
determining a ground feature comprising the second section to be associated with a launch vehicle comprising the first section; and
associating together the first section and the second section based in part on the locked position for the release feature, along with the first section and the second section.

18. The method of claim 16, further comprising:
using a threaded retainer to remove loading on the release mechanism in the locked position for the first section and the second section.

19. The method of claim 16, further comprising one or more of:
receiving, using at least one lock port of the second section, first media for the pneumatic-pressure primary engagement or allowing, by a coil spring of the second section, a bias for the mechanical-pressure primary engagement;
receiving, using at least one unlock port, second media for the pneumatic-pressure primary disengagement; or
receiving, using a purge port, a third media for a purge through internals of the mandrel.

20. The method of claim 16, further comprising:
using a release rod, which is through the mandrel and which is biased to also be in the locked position with the release feature, for the mechanical-pressure secondary engagement; and
removing the release rod to an unlocked position for the mechanical-pressure secondary disengagement between the first section and the second section and through the receiver.
